(19) United States
(12) Patent Application Publication
(10) Pub. No.: US 2008/0003052 A1
(43) Pub. Date: Jan. 3, 2008

(54) Delivery device for liquid or semi-solid materials

(76) Inventors: MeeWha Lee, Appleton, WI (US); Timothy Patrick Clare, Appleton, WI (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/454,649

(22) Filed: Jun. 16, 2006

(51) Int. Cl. B43K 7/00; B43M 11/06

(52) U.S. Cl. 401/209; 401/183

(57) ABSTRACT

The present invention provides a delivery device for delivering a liquid or semi-solid material to a surface. The delivery device has a body having an opening at one of the longitudinal ends, wherein the opening has a first size and a first shape. An applicator is positioned within an interior volume of the body between the ends of the body. This applicator is movable in the longitudinal direction within the interior volume of the body and the applicator has a size and a shape such that the opening retains at least a portion of the applicator within the interior volume of the body. Also within the interior volume is a liquid or semi-solid material, which is to be applied to the surface. Protecting the applicator and liquid or semi-solid material, located within the interior volume of the body, is a cover which may positioned at least at the opening and which covers the opening.

### FIELD OF THE INVENTION

The present invention relates to a delivery device for liquid and/or semi-solid (pasty) materials. More particularly, the present invention relates to a single use delivery device.

### BACKGROUND OF THE INVENTION

Delivery of various liquid and/or paste-like (semi-solid) compositions to a surface is needed or desired in many different occasions. In situations where a person in need of a liquid or paste-like composition is away from home or the person needs the liquid or paste-like composition in a single dose or a single use portion, it is often desirable to have a single use applicator to deliver the liquid or paste-like composition to a surface. Examples of such situations include, for example, first aid applications, such as, cleaning a wound, medical treatment of a wound to prevent infections or promote healing and the like, operating room disinfecting solutions, cleaning solutions for skin and hard surfaces, shoe polish, hand or skin lotions, cosmetics, medicaments for treating skin sores, such as cold sores and the like. The delivery device should allow the user to deliver the liquid or pasty composition to a desired surface without the liquid or pasty composition coming into contact with the user's hands or body, unless the desired surface is the user's hands or body. In addition, the delivery device should effectively store the composition without leakage or deterioration of the composition prior to use.

Delivery devices for delivering a liquid or pasty composition to a surface are known in the art. Many different designs have been suggested; but each has drawbacks which makes the designs less desirable as a single use applicator. Some of the drawbacks include, for example, cost, ease of use, the ability to accurately apply the composition to the desired area of the surface, and the like.

One design taught in the prior art is a roller ball applicator. Numerous roller ball applicators are known in the art and these roller balls have been used to apply various liquid or semi-solid (pasty) compositions. Typically, roller balls have been used to apply cosmetics and deodorants. Generally, roller ball delivery devices are made to have a rigid container and the roller ball is held in place at the opening of the container by using a rib or ridge which keeps the ball from falling into or falling out of the rigid container. These roller ball delivery devices are typically costly to produce; in terms of the components used to produce the delivery device and in terms of labor cost to assemble the delivery device. As a result, roller ball applicators have not been widely used as a single use delivery device. In addition, the location of the roller ball is fixed, causing the delivery device to be larger than necessary, making the prior roller ball delivery devices too large or inconvenient to carry as a single use delivery device.

Other single use delivery devices known to those skilled in the art include delivery devices having a stylus made of a liquid permeable material, such as an open cell foam. Often these delivery devices typically have an applicator which does not allow the liquid or pasty composition to be accurately placed on the desired surface by a user. Many times, in the case of liquids, the foam applicator will leak during use. In addition, many of the foam applicators have a size or shape that do not allow accurate or pin-point placement on the surface.

There is a need in the art for an economical and easy to use liquid or semi-solid composition delivery device which may be used as a single use delivery device for applying a liquid or semi-solid material to a surface.

### SUMMARY OF THE INVENTION

Generally stated, the present invention provides a delivery device for delivering a liquid or semi-solid material to a surface. The delivery device has a body having a longitudinal length, at least one side, a proximal longitudinal end, a distal longitudinal end, and an interior volume or chamber located between the proximal and distal longitudinal ends capable of holding a liquid or a semi-solid material. The proximal longitudinal end and the distal longitudinal end are joined together by the side of the delivery device. In addition, an opening is located at the distal longitudinal end, wherein the opening has a first size and a first shape. An applicator is positioned within the interior volume of the body between the proximal longitudinal end and the distal longitudinal end. This applicator is movable within the interior volume of the body in the longitudinal direction and the applicator has a second size and a second shape such that the opening will retain at least a portion of the applicator within the interior volume of the body. Stored within the interior volume is a liquid or semi-solid material, which is to be applied to the surface.

In another embodiment of the present invention, protecting the applicator and liquid or semi-solid material located within the interior volume of the body is a cover, which may be positioned at the opening and which covers the opening. The cover is openable, removable or rupturable and is open, removed or ruptured prior to delivering the liquid or semi-solid material from the delivery device.

In one embodiment of the present invention, the side or sides of the body are deformable under a compressive force. In this embodiment, the side or sides of the body are configured to collapse into the interior volume of the delivery device, when a compressive force is applied to the side or sides of the body. The side or sides are configured to move the applicator from a storage position below the opening to a use position such that at least a portion of the applicator protrudes beyond the opening and distal longitudinal end of the delivery device. In a further aspect of this embodiment, the side or sides may be configured such that when deformed, the side or sides form a stop for the applicator which prevents the applicator from migrating into the interior volume during use.

In an embodiment of the present invention, the applicator may have an abrasive surface which can be used to clean or exfoliate the surface in which the liquid or semi-solid material is being applied.

In another embodiment of the present invention, the applicator may have a surface which is soft to the touch of the skin of a user.

In another embodiment of the present invention, the delivery device may be provided with a seal in the interior volume which serves to hold the fluid or semi-solid material near the proximate longitudinal end and away from the opening of the delivery device.

In further embodiment of the present invention, provided is a delivery device for applying a liquid or semi-solid material to a surface. The delivery device has a body having a proximal longitudinal end, a distal longitudinal end, at least one side panel joining the proximal longitudinal end and a distal longitudinal end, and a longitudinal length. The proximal longitudinal end, distal longitudinal end and the at least one side panel define an interior volume having an interior diameter. The at least one side panel has an interior surface and an exterior surface. A spherical applicator ball having an outer diameter is located within the interior volume of the body. The outer diameter of the spherical ball is such that the spherical ball is in contact with the interior surface of the body. An opening is located at the distal longitudinal end. This opening has a diameter which is smaller than the outer diameter of the spherical ball, such that the spherical ball is held within the body by the opening. The delivery device also has a cover which serves to protect the applicator and any material stored within the interior volume of the delivery device.

In an additional embodiment of the present invention, provided is a method for applying a liquid or semi-solid material to a surface. The method has the steps of 1) providing a delivery device according to an embodiment of the present invention, 2) removing or rupturing the cover from the distal longitudinal end of the body, 3) positioning the applicator from a storage position below the opening of the delivery device into a use position by moving a portion of the applicator through the opening of the delivery device; and 4) contacting the applicator with the surface. By contacting the applicator with the surface, the liquid or semi-solid material is transferred from the delivery device to the surface.

In a further embodiment of the method of applying a liquid or semi-solid material to the surface of the present invention, the positioning of the applicator is accomplished by applying a compressive force to the at least one side of the body. This compressive force causes the at least one side of the body to deform and collapse into the interior volume which results in the applicator moving from a position below the opening to a position such that the applicator at least partially protrudes through the opening of the delivery device.

### BRIEF DESCRIPTION OF THE DRAWINGS

FIG. 1 shows a perspective view of a delivery device of the present invention prior to opening, with the applicator in a storage position, below the distal plane at the opening.

FIG. 2 shows a perspective view of a delivery device of the present invention with the cover partially open, with the applicator in a storage position, below the distal plane at the opening.

FIG. 3 shows a perspective view of a delivery device of the present invention with the cover removed and the applicator being moved into a use position, above the distal plane of the opening.

FIG. 4 shows a cut-away cross-sectional view of a delivery device of the present invention with a cover which is integral with the body.

FIG. 5 shows a cut-away cross-sectional view of a delivery device of the present invention with the applicator in a storage position, below the distal plane at the opening.

FIG. 6 shows a cut-away cross-sectional view of a delivery device of the present invention with the applicator in a use position above the distal plane at the opening and the sides of the body being in a collapsed position.

FIGS. 7 A and 7B show a cut-away cross-sectional view of a delivery device of another embodiment of the present invention, showing the storage position FIG. 7A of the applicator and use position of the applicator FIG. 7B and with an internal seal.

FIG. 7C shows a cut-away cross-sectional view of a delivery device of another embodiment of the present invention having side seals.

FIG. 8 shows a perspective view of a delivery device of the present invention with the cover removed and the applicator being moved into a use position while in the hand of a user.

FIG. 9 shows a perspective view of a delivery device of the present invention in the hand of a user in the use position.

### DEFINITIONS

It should be noted that, when employed in the present disclosure, the terms “comprises”, “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As used herein, the terminology such as “vertical”, “horizontal”, “top”, “bottom”, “front”, “back”, “end” and “sides” are referenced according to the views presented. It should be understood, however, that the terms are used only for purposes of description, and are not intended to be used as limitations. Accordingly, orientation of an object or a combination of objects may change without departing from the scope of the invention. As a point of reference for the claims and in the present specification, the term “top” refers to a panel or side of the package with an opening device or opening.

As used herein, the term “opening” refers to a portion of the delivery device which allows the liquid or semi-solid material to be released from the interior volume of the delivery device.

As used herein, the term “opening device” refers to a structure on or near the cover which allows a user to easily remove the cover from the delivery device to access the applicator and the liquid or semi-solid material within the interior volume of the delivery device. Examples of opening devices include, for example, tabs, lines of weakness, and other similar items which make it easier for a user to open the delivery device.

It should be understood that the terms “semi-solid”, “pasty” and/or “paste-like” are intended to mean materials which are flowable under pressure. Semi-solid compositions include creams, ointments, gel-like materials and other similar materials.

As used herein, the term “applicator” refers to the structure of the delivery device which transfers the liquid or semi-solid material from the interior volume of the delivery device to the surface to be treated. The applicator is the portion of the delivery device which comes into contact with the surface being treated with the liquid or semi-solid material.

As used herein, the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and random symmetries.

### DETAILED DESCRIPTION OF THE INVENTION

In the following detailed description of the present invention, reference is made to the accompanying drawings which form a part hereof, and in which is shown by way of illustration, specific embodiments in which the inventions may be practiced. These embodiments are described in sufficient detail to enable those skilled in the art to practice the invention, and it is to be understood that other embodiments may be utilized and that mechanical, procedural, and other changes may be made without departing from the spirit and scope of the present invention. The following detailed description is, therefore, not to be taken in a limiting sense, and the scope of the present invention is defined only by the appended claims, along with the full scope of equivalents to which such claims are entitled.

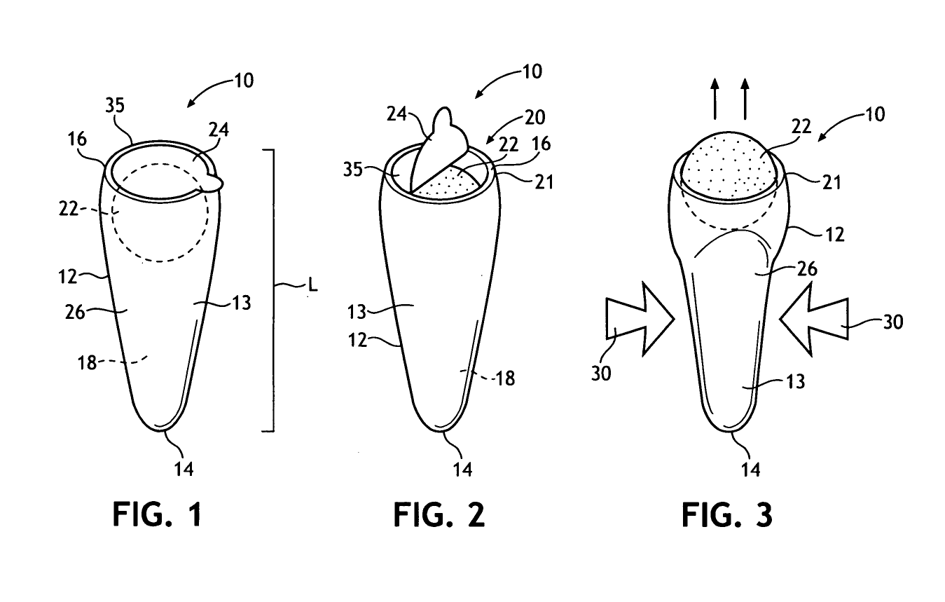

To obtain a better understanding of the present invention, attention is directed to FIGS. 1-3. Shown in FIGS. 1, 2 and 3, is a delivery device 10 for delivering a liquid or semi-solid material to a surface. The delivery device 10 has a body 12 which has a longitudinal length L, a proximal longitudinal end 14, a distal longitudinal end 16, at least one side 13 and an interior volume or chamber 18 located between the proximal and distal longitudinal ends 14, 16. The proximal and distal longitudinal ends 14, 16 are connected together by the at least one side 13. The interior volume 18, which is formed by the at least one side 13 and the proximal and distal longitudinal ends, is capable of holding a liquid or a semi-solid material. Located at the distal longitudinal end 16 is an opening 20. The opening 20 has a first size and a first shape. Positioned within the interior volume 18 of the body between the proximal longitudinal end 14 and the distal longitudinal end 16 is an applicator 22. The applicator 22 is movable in the longitudinal direction L within the interior volume 18 of the body 12. Also, the applicator has a second size and a second shape such that the opening 20 retains at least a portion of the applicator 22 within the interior volume 18 of the body 12. Positioned over the opening 22 and covering the opening is a cover 24. The cover 24 is removeable and is typically removed prior to use. Also shown in FIGS. 1-3, is a liquid or semi-solid material 26 located in the interior volume 18, which may be dispensed for the delivery device 10 of the present invention.

The body 12 of the delivery device may have a tube-like or hollow-like structure, with the proximal longitudinal end 14 being closed and the distal longitudinal end 16 having an opening 20. In the alternative, the distal longitudinal end may not contain an opening but is capable of forming an opening. The hollow portion of the tube-like structure has an interior volume 18 which is capable of holding an applicator 22 and a liquid or semi-solid material 26. The body 12 of the present invention may be prepared from a variety of materials. Typically, the materials used to prepare the body 12 should be liquid and gas impermeable so that the liquid or semi-solid material can be retained in the interior volume 18 of the body 12 prior to use. In addition, the materials selected to form the body 12 should also be selected so that the side or sides 13 of the body 12 are deformable when compressive force is applied to the at least one side 13 of the body. Suitable materials include materials such as paperboard, molded thermoplastic polymers, thermoplastic polymer films, molded elastomeric polymers, elastomeric polymer films, metal films or foils, and laminates of one or more of these materials. From the standpoint of cost and ease of processing, typically the materials used to produce the body will be polyolefin, such as polyethylene or polypropylene.

The body 12 of the delivery device 10 may be made of a single piece of material or multiply pieces of material. In the case where there is a single piece of material, the body may be prepared using methods known to those skilled in the art, such as injection molding, blow molding or other known molding processes. The body 12 of the delivery device 10 may also be prepared from a tube-like blank. When a tube-like blank is used to form the body 12, the proximal longitudinal end 14 of the body will need to be sealed, using a method known to those skilled in the art. Alternatively, the single piece of material may be folded over onto itself, resulting in side seams. Other methods of forming the body 12 of the delivery device 10, include using multiple pieces of the material. When multiple pieces are used, the presence of side seams and an end seam may be present which will require sealing. The method of forming the delivery device 10 or the body 12 of the delivery device is not critical to the present invention.

The proximal longitudinal end 14 of the delivery device may be sealed, if needed, in a manner which will prevent the applicator 22 and the liquid or semi-solid material 26 from leaking or otherwise escaping from the delivery device 10 during storage or use. Likewise, any side seam that may be present may be sealed using a similar sealing method. Suitable sealing methods include heat sealing, ultrasonic sealing, adhesive sealing, crimping, pressure bonding or a combination thereof, depending on materials used to prepare the body of the delivery device.

The shape of the delivery device 10 can be a variety of shapes. For example, the delivery device may have a generally conical shape, a cylindrical shape, an oval shape or any other shape that is convenient to prepare so long as the delivery device can easily dispense the liquid or semi-solid material contained within the interior volume 18 of the body 12 of the delivery device 10. As is shown in FIGS. 1-3, the delivery device 10 has a generally paraboloidal shape.

The distal longitudinal end 16 of the body 12 has an opening 20 which is capable of allowing the liquid or semi-solid material to be released from the delivery device. The opening 20 has a first size and a first shape. The size and the shape of the opening should be selected to be complimentary to the size and shape of the applicator 22. For example, if the shape of the applicator is spherical, cylinderical or conical, the shape of the opening should be round to accommodate the applicator 22. If the applicator is cylindrical in shape, the opening in the delivery device could be rectangular in shape. In addition, the size of the opening should be such that the opening will prevent the applicator 22 from falling out of the dispenser during use. For example, the opening should be slightly smaller than the size of the applicator. This will prevent the applicator 22 from being ejected or otherwise removed from the body 12 of the delivery device 10 prior to or during use. The opening also may have a flange or lip structure 21 which will allow a cover to be held onto the delivery device 10.

The applicator 22 of the present invention allows the liquid or semi-solid material to be dispensed from the delivery device 10 in a controlled manner. The applicator 22 has a second size and a second shape which is complimentary to the size and shape of the opening 20, so that the applicator will not be accidentally lost from the applicator before or during use. Suitable shapes for the applicator 22 include, for example, spherical, cylindrical, conical, paraboloidal or other similar shapes suitable for applying a liquid or semi-solid material to a surface. The applicator 22 may be prepared from a liquid impervious material or may be prepared from a liquid pervious material. In one embodiment of the present invention, the applicator 22 has a spherical or a cylindrical shape. As a result, the applicator 22 is free to roll or move when it is positioned within the opening 20 to allow the liquid or semi-solid material to be picked-up by the portion of the applicator 22 which is facing the interior volume and rolled around to the opening side of the applicator 22 to apply the liquid or semi-solid material to the surface to be treated. When the applicator 22 is a shape that will not roll or move when the applicator 22 is in the dispensing or use position, such as a conical or paraboloidal shape, the delivery device should be made from a material which is liquid permeable, so that the liquid or semi-solid material can pass through the applicator 22 and be dispensed from the interior volume 18 of the delivery device 10.

Suitable liquid impermeable materials include thermoplastic or thermoset polymeric materials such as polyolefins, polyesters, polyamides, silicones and the like; metal, such as steel, glass or any other material. The material could be solid or hollow, provided that the applicator 20 will not break or become damaged during storage or use. Suitable liquid permeable include, for example, open cell foams, fibrous masses, such as a cotton ball, sintered materials with sufficient open area to communicate the fluid to the user, or any other material which will allow the liquid or semi-solid material to pass through applicator 22.

The applicator 22 may be prepared from a material which is abrasive or may be made to be abrasive. When the applicator 22 is abrasive, the delivery device 10 can be used to clean or scrub a surface in which the liquid or semi-solid material is being applied, in addition to delivering the liquid or semi-solid material to the surface to be treated. Abrasive surfaces may be prepared using known methods to those skilled in the art, such as applying an abrasive material to the surface of the applicator 22. Abrasive applicators may also be used to exfoliate human skin when the delivery device contains a skin treating composition. In the alternative, the applicator 22 may have a soft surface, meaning a surface which is soft to the touch to human skin. Soft feeling applicators can be used to apply moisturizers or creams to the human skin. Suitable soft applicators 22 can be prepared from elastomeric polymers, such as polyurethanes or silicone polymers. Soft applicators may also be formed from foams or fibrous masses.

The opening 20 of the delivery device 10 may be sealed by a cover 24. Although a cover 24 is not required if the applicator 22 is capable of holding the liquid or semi-solid material within the delivery device 10 having a cover 24 may be advantageous. The cover 24 is a gas and liquid impermeable material which serves to hold the liquid or semi-solid material 16 within the delivery device 10, thereby preventing leakage or evaporation of the liquid or semi-solid composition 26. The cover also serves to keep the applicator 22 and liquid or semi-solid 26 from becoming contaminated during storage and before use. The cover 24 is removable prior to use by the user. The cover 24 may be a separate piece of material from the body 12 or may be made from the same material as the body and may be an extension of the body 12. If the cover is a separate piece of material from the body, suitable materials include, for example, polymeric films, metal foils, papers or laminates thereof. Examples of each include, for example, a polyethylene film, aluminum foil, paper board and the like. If the cover is an extension of the body material, the cover will be prepared from the same material as the material used to form the body. It is also possible for the cover 24 to remain attached to the delivery device 10 once the cover 24 is opened, or the cover 24 may be completely or partially removed from the delivery device 10 prior to use.

The cover 24 may be held in place to the body using known methods, such as using an adhesive between cover 24 and the body 12, or the other known methods such as heat sealing, pressure sealing, ultrasonic sealing and the like or a combination of these sealing procedures, depending on the material used to prepare the cover. For example, if the cover is made from a similar material used to make the body, the cover may be heat sealed or ultrasonically sealed to the body. Mechanical methods known to those skilled in the art may also be used to secure the cover 24 to the body 12 of the delivery device 10. For example, the cover could be held in place by using a threaded cap and a threaded delivery device or the cap may be crimped onto the delivery device. In one embodiment of the present invention, the cover 24 is sealed to the flange 21 by using an adhesive. In addition, the cover may be imparted with an opening aid, which is a tab 25 or handle, in which the user can grasp the cover 12.

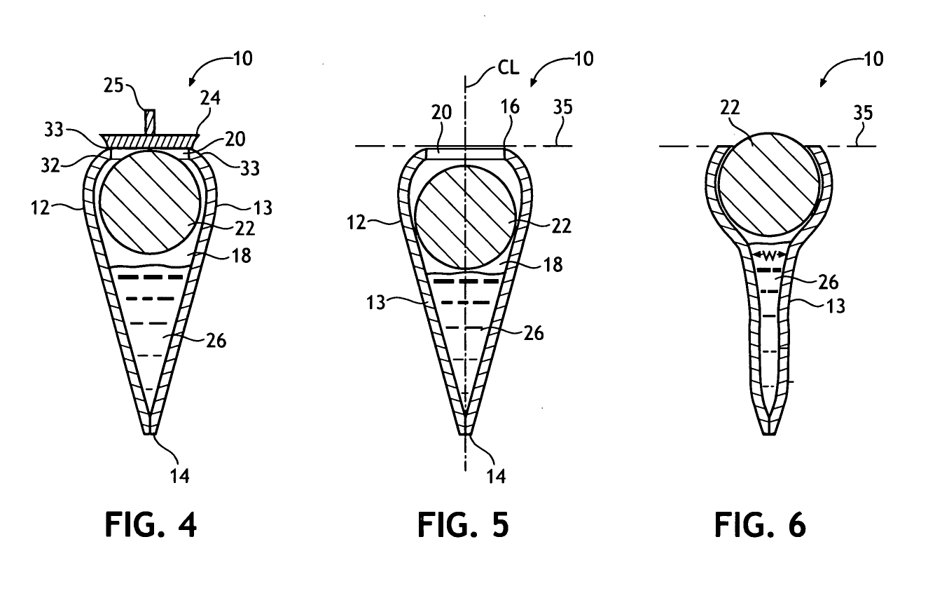

When the cover 24 is an extension of the body 12 and the cover is integral with the body, as is shown in FIG. 4, the cover may be formed with the body. To facilitate the opening of the integral cover, an opening device 33 may be associated with the cover. The opening device 32 allows for the separation of the cover from the body without damaging the body. One example of an opening device is a line of weakness between the cover 24 and the body 12. An example of a line of weakness is a score line 33. Other opening devices may also be used. An opening aid 25 may also be used when the cover 24 is integral with the body 12. As is shown in FIG. 4, the opening aid is a tab 25 which will allow the user to grasp and, in the case of FIG. 4, twist the cover to break the cover 24 away from the body 12 of the delivery device 10.

The delivery device 10 of the present invention has an imaginary distal plane 35 which is essentially parallel with the top of the opening 20 or the cover 24. In FIGS. 1 and 2, the cover 24 also represents the distal plane 35. By being “essentially parallel”, it is intended that the plane is within 0-10 degrees of being parallel with the top of the opening 20. In one embodiment of the present invention, the distal plane 35 is essentially perpendicular to the longitudinal length L of the delivery device 10 as measured from the longitudinal center line CL of the delivery device. Prior to opening, as is shown in FIGS. 1, 2 and 5, the applicator 22 is positioned below the distal plane 35. That is, the applicator is below the mouth of the opening 20 and below the cover. By having the applicator below the distal plane 35 before use, the delivery device 10 of the present invention is more compact than a delivery device in which the applicator is positioned below the mouth of the opening and above the distal plane 35. Prior to use, the applicator 22 is moved into a dispensing position such that a portion of the applicator 22 is above the distal plane 35 and a portion of the applicator 22 is below the distal plane 35 and within the interior volume 18. As was mentioned above, the size and shape of the opening serves to hold the applicator 22 within the delivery device. One method of moving the applicator into position for use will be described in more detail below.

The applicator 22, when in its storage position, is below the distal plane, may also serve to keep the liquid or semi-solid material away from the opening 20 and cover 24 prior to use. As is shown in FIG. 5, in one embodiment of the present invention, the body 12 is tapered, meaning the distance between the side 13 of the body becomes smaller as the proximate end 14 of the delivery device 10 is reached. In another embodiment of the present invention, the width of the body 12 is approximately equal to the width or diameter of the applicator 22. In either case, the applicator 22 comes into contact with the side walls 15 of the body, thereby keeping the liquid or semi-solid material in the interior volume 18 near the proximate end 14 of the delivery device 10 until the applicator 22 is moved into the use or application position, above the distal plane 35. Essentially, the applicator 22 may form a seal with the interior surface of the at least one side 13 so that the liquid or semi-solid material does not migrate to the opening 20 during storage or prior to use. However, it is noted that the applicator 22 may not adequately perform this function if the applicator 22 is porous or is otherwise liquid permeable. In this situation, the delivery device may included an internal seal.

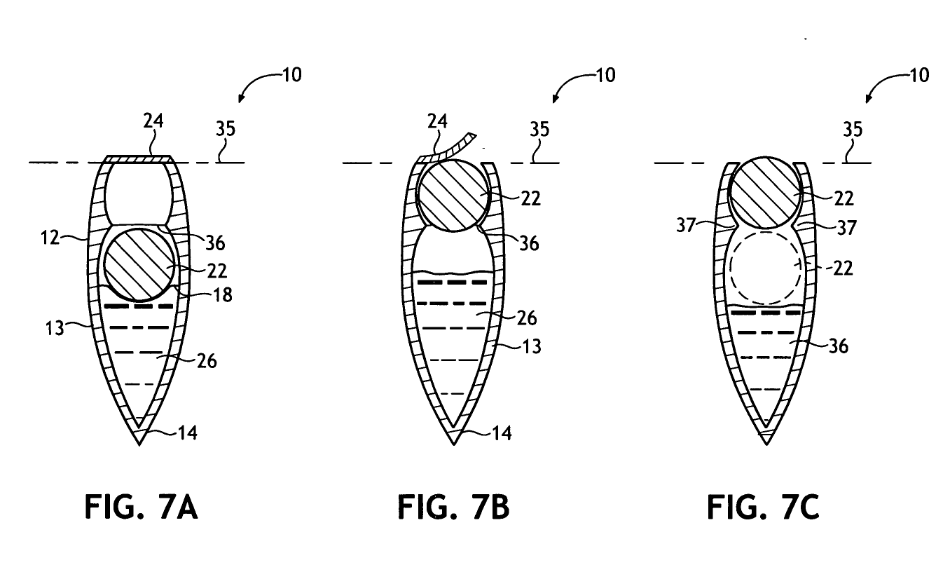

In the case where the applicator is porous or otherwise liquid permeable, the interior volume may be provided with a seal 36, which functions to keep the fluid or semi-solid material near the proximate end longitudinal end 14 of the delivery device 10, prior to use. The seal 36 may be a septum, divider or other means may be used to keep the liquid or semi-solid material near the proximate end 14 of the delivery device 10 prior to use. In addition, the seal 36 may also be used even if the applicator 22 is non-porous or non-liquid impermeable. For example, the seal 36 may be made from the same material used to prepare the body 12 of the dispenser. The seal 36 may be formed in a manner to make it frangible so that the applicator 22 can break the divider when a force is applied to the applicator 22 to move the applicator 22 from the storage, shown in FIG. 7A into a use position, as is shown 7B. As can be seen in FIG. 7B, when the applicator 22 has been moved into the use position, the seal 36 has been ruptured and only remnants of the seal 36′ remain. Another method of preventing the liquid or semi-solid 26 near the proximate longitudinal end is to have the interior surface delivery device prepared from an elasticized material that will contact the applicator and form a seal. As can be seen in FIG. 7C, the interior surface may have extensions 37 which form a seal with the applicator 22 in the storage position. These extensions 37 also serve to hold the applicator 22 in the use position, preventing the applicator from migrating back into the interior volume.

In one embodiment of the present invention, the sides 13 of the body 12 of the delivery device 10 are deformable. As is shown in FIGS. 3 and 6, the at least one side or sides 13 are deformable when a compressive force 30 is applied to the side or sides 13 of the body. This will cause the sides 13 of the body 12 to collapse into the interior volume 18. Deformability of the sides 13 can be accomplished by numerous methods including, selection of materials making-up the body, providing lines of weakness or creases in the sides 13 of the body 12 which facilitate collapsing the side walls 13 inward toward the interior volume. As the sides 13 are pushed inward toward the interior volume 18, the applicator 22 is forced upward towards the opening 20 and above the distal plane 35 into the dispensing position, shown in FIGS. 3 and 6. In a further aspect of this embodiment, the side or sides 13 of the delivery device, when deformed, form a stop for the applicator 22 which prevents the applicator from migrating into the interior volume during use. That is, the interior volume or chamber becomes narrowed such that the size and shape of the applicator is larger than the width W of the interior volume 18. This configuration is shown in FIG. 6.

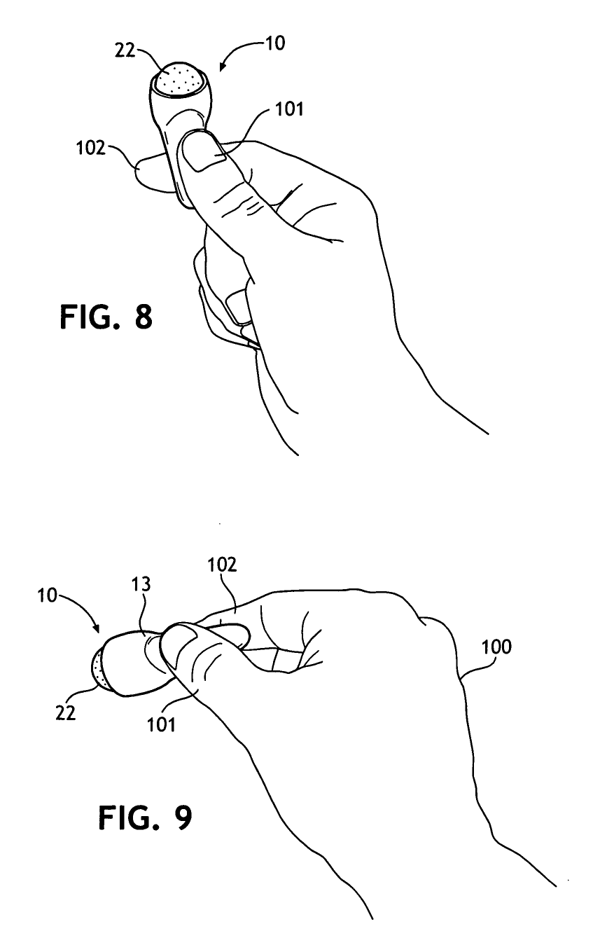

To use the delivery device of the present invention, a user removes the cover 24 from the delivery device 10 to reveal the opening 20. Next, the user applies a compressive force 30 to the side or sides 13 of the body 12 of the delivery device 10 which causes the sides 13 of the body to collapse inward towards the interior volume 18 of the delivery device 10. At the same time, the interior portion or the side walls 13 contact the applicator 22; which in turn causes the applicator 22 to be repositioned and moved upward into and through the opening 20 and above the distal plane 35, as is shown in FIGS. 3 and 6. It is noted that only a portion of the applicator 22 is positioned through the opening while the remainder of the applicator remains within the interior volume 18 of the delivery device. This new applicator position shown in FIGS. 3 and 6 is referred to as the dispensing position or use position. Typically, a user will apply the compressive force needed to collapse the sides 15 of the body by squeezing the sides 15 between the thumb 101 and forefinger 102, as is shown in FIG. 8.

Once the applicator 22 is positioned into the dispensing position or use position, above the distal plane, the delivery device 10 may be used to apply the liquid or semi-solid composition to a surface. As is shown in FIG. 9, typically the delivery device 10 is rotated in a user's hand 100 such that the applicator 22 is lower than the liquid or semi-solid material present in the interior volume 18 of the delivery device 10. The deformed side or sides 13 form a place for the user to grasp the delivery device 10, as is shown in FIG. 9. Gravity allows the liquid or semi-solid material to contact the applicator 22. Once in contact with the applicator 20, the liquid or semi-solid material is transferred to the surface being treated by the applicator. That is, the applicator is contacted with the surface to be treated with the liquid or semi-solid material (not shown). In the case where the applicator 22 is a spherical shape or roller ball, the spherical applicator is rolled along the surface being treated, which results in the liquid or semi-solid material being transferred to the applicator 22 on the interior volume 18 side of the applicator 22. As the applicator 22 is rolled along the surface, the applicator 22 rotates within the delivery device 10, such that the side of the applicator 22 is in contact with the liquid or semi-solid material and rotates to the opening side of the delivery device and transfers the liquid or semi-solid material to the surface.

In the case where the applicator is porous or otherwise liquid permeable, the interior volume may be provided with a seal 36, which functions to keep the fluid or semi-solid material near the proximate end longitudinal end 14 of the delivery device 10, prior to use. The seal 36 may be a septum, divider or other means may be used to keep the liquid or semi-solid material near the proximate end 14 of the delivery device 10 prior to use. In addition, the seal 36 may also be used even if the applicator 22 is non-porous or liquid impermeable. For example, the seal 36 may be made from the same material used to prepare the body 12 of the dispenser. The seal 36 may be formed in a manner to make it frangible so that the applicator 22 can break the divider when a force is applied to the applicator 22 to move the applicator 22 from the storage, shown in FIG. 7A into a use position, as is shown in FIG. 7B. As can be seen in FIG. 7B, when the applicator 22 has been moved into the use position, the seal 36 has been ruptured and only remnants of the seal 36′ remain. Another method of preventing the liquid or semi-solid 26 near the proximate longitudinal end is to have the interior surface delivery device prepared from an elasticized material that will contact the applicator and form a seal. As can be seen in FIG. 7C, the interior surface may have extensions 37 which form a seal with the applicator 22 in the storage position. These extensions 37 also serve to hold the applicator 22 in the use position, preventing the applicator from migrating back into the interior volume.

In an alternative embodiment, the cover 24 could be formed from a material that opens or ruptures when a force 30 is applied to the sides 13 of the body. In this embodiment of the present invention, the cover could be a film or foil-like material which will rupture as the applicator 22 is forced against the underside of the cover (the side of the cover which faces the interior volume of the body). Thin films or foils with lines of weakness, such as perforations or scores could be used in the aspect of the present invention. In this configuration of the present invention, the user applies a compress force 30 to the sides 13 of the body 12 of the delivery device 10 which causes the sides 13 of the body to collapse inward towards the interior volume 18 of the delivery device 10. At the same time, the interior portion or the side walls 13 contact the applicator 22, which causes the applicator 22 to be moved upward into the opening 20 and above the distal plane 35, as is shown in FIGS. 4 and 6. When a cover 24 is still in place, the applicator 20 will be forced toward the cover and through the cover when the force is applied. Typically, a user will apply the compressive force needed to collapse the sides 15 of the body by squeezing the sides 13 of the body between the thumb 101 and forefinger 103, as is shown in FIG. 8.

To prepare the delivery device 10 of the present invention, typically the body of the device, with the opening at the distal longitudinal end is formed using a molding process or other suitable manufacturing process. If the cover is integral with the body, the cover is formed during the molding process. If the cover is separate, the cover is applied to the after molding using known methods. The proximate longitudinal end of the dispenser is molded in an open position, such that the interior space is readily accessible. Generally, the body of the delivery device will be turned upside down such that the opening is lower than the proximate longitudinal end. The applicator is inserted into the interior space and then the liquid or semi-solid composition is inserted into the interior space. Once the dispenser is loaded with the applicator and the liquid or semi-solid composition, the proximate longitudinal end is sealed using one or more of the methods described above.

The delivery device 10 of the present invention can be used to dispense a wide variety of liquids or semi-solid materials to a surface. The delivery device is especially adapted as a single use delivery device and applicator. Suitable liquids or semi-solid materials which can be dispensed from the delivery device include, medical compositions, such as first aid compositions, skin sealants, sterilization compositions for operating rooms or doctor's offices, acne treatments, wart treatments, body fungus treatments, poison ivy treatments or other similar treatment liquids or semi-solid materials which may benefit from a single use applicator to prevent contamination of the applicator or spreading of the problem being treated to other areas of the body. Other liquid or semi-solid materials which may be dispensed from the delivery device, include, hand cleaning compositions, antiperspirants, makeup, hard surface cleaners and the like. These liquids and semi-solid materials are intended to be exemplary and the present application should not be construed to be limited to those compositions which are disclosed.

The delivery device of the present invention could be part of a kit, wherein the kit contains the delivery device and instructions on how to use the delivery device. The instructions may be applied to the delivery device, to packaging used to package the delivery device or a plurality of delivery devices.

Although the present invention has been described with reference to various embodiments, those skilled in the art will recognize that changes may be made in form and detail without departing from the spirit and scope of the invention. As such, it is intended that the foregoing detailed description be regarded as illustrative rather than limiting, and that it is the appended claims, including all equivalents thereof, which are intended to define the scope of the invention.

1. A delivery device for delivering a liquid or semi-solid material to a surface, said delivery device comprising
a) a body comprising a longitudinal length, at least one side, a proximal longitudinal end, a distal longitudinal end, and an interior volume located between the proximal and distal longitudinal ends capable of holding a liquid or a semi-solid material, wherein the at least one side connects the proximal longitudinal end to the distal longitudinal end;
b) an opening located at the distal longitudinal end, the opening having a first size and a first shape; and
c) an applicator positioned within the interior volume of the body between the proximal longitudinal end and the distal longitudinal end, the applicator being movable in the longitudinal direction within the interior volume of the body, the applicator has a second size and a second shape such that the opening retains at least a portion of the applicator within the interior volume of the body;

2. The delivery device according to claim 1, further comprising d) a cover positioned at least at the opening which covers the opening.

3. The delivery device according to claim 2, wherein the cover is removable or rupturable.

4. The delivery device according to claim 2, further comprising a liquid or semi-solid material located within the interior volume of the body.

5. The delivery device according to claim 2, wherein the applicator is located below a distal plane prior to opening, removal or rupturing of the cover, the distal plane being essentially parallel with the opening.

6. The delivery device according to claim 5, wherein the applicator is moved above the distal plane to deliver the liquid or semi-solid material from the delivery device to a surface.

7. The delivery device according to claim 4, wherein the liquid or semi-solid material is located between the proximal longitudinal end and the applicator, prior to removal of the cover.

8. The delivery device according to claim 4, wherein the applicator retains the liquid or semi-solid material within the interior volume of the body between the applicator and the proximate end of the body prior to delivery of the liquid or semi-solid material to a surface.

9. The delivery device according to claim 1, wherein the applicator comprises an abrasive surface.

10. The delivery device according to claim 1, wherein the applicator has a soft surface.

11. The delivery device according to claim 10, wherein the applicator comprises a surface comprising a foam or an elastomeric polymeric material.

12. The delivery device according to claim 1, wherein the applicator comprises a spherical shape.

13. The delivery device according to claim 1, wherein the at least one side of the body comprises a material which is deformable under pressure.

14. The delivery device according to claim 13, wherein the at least one side of the body collapses under a compressive force applied to an exterior surface of the at least one side of the body such that the at least one side of the body forms a stop for the applicator, wherein the stop prevents the applicator from migrating back into the interior volume of the delivery device during use.

15. The delivery device according to claim 14, wherein the body comprises a polymeric material.

16. The delivery device according to claim 4, wherein the body comprises a first portion and a second portion, the first portion being located near the proximal end of the body and the second portion being located near the distal end of the body, the liquid or semi-solid material being located in the first portion and the applicator being located in the second portion of the body.

17. The delivery device according to claim 16, further comprising a seal within the interior volume, wherein the seal serves to prevent the fluid or semi-solid material being located near the opening prior to use.

18. The delivery device according to claim 17, wherein the seal is a frangible seal.

19. A delivery device for applying a liquid or semi-solid material to a surface, said delivery device comprising
a. a body having a proximal longitudinal end, a distal longitudinal end, at least one side panel joining the proximal longitudinal end and distal longitudinal end, and a longitudinal length, wherein the proximal longitudinal end, distal longitudinal end and the at least one side panel defines an interior volume having an interior diameter, the at least one side panel having an interior surface and an exterior surface;
b. a spherical applicator ball having an outer diameter, wherein the outer diameter of the spherical ball is such that the spherical ball is in contact with the interior surface of the body,
c. an opening located at the distal longitudinal end, the opening having a diameter which is smaller than the outer diameter of the spherical ball, such that the spherical ball is held within the body by the opening.

20. The delivery device according to claim 19, further comprising
d) a cover positioned at least at the opening which covers the opening, the cover is openable, removable or rupturable and is opened, removed or ruptured prior to delivering a liquid or semi-solid material from the delivery device; and
e) a liquid or semi-solid material located within the interior volume of the body.

21. The delivery device according to claim 19, wherein the applicator is located below a distal plane prior to the opening, removal or rupturing of the cover, the distal plane being essentially parallel with the opening.

22. The delivery device according to claim 21, wherein the applicator is moved above the distal plane to deliver the liquid or semi-solid material from the delivery device to a surface.

23. The delivery device according to claim 19, wherein the body deforms under pressure such that the body forms a stop for the applicator, which prevents the application from falling back into the interior volume during use.

24. A method for applying a liquid or semi-solid material to a surface, said method comprising
1) providing a delivery device according to claim 4;
2) opening, removing or rupturing the cover from the distal longitudinal end of the body;
3) positioning the applicator from a storage position below the opening of the delivery device into a use position by moving a portion of the applicator through the opening of the delivery device; and
4) contacting the applicator with the surface, thereby transferring the liquid or semi-solid material from the delivery device to the surface.

25. The method of claim 24, wherein the positioning of the applicator comprises applying a compressive force to the at least one side of the body, thereby causing the at least one side of the body to deform and collapse into the interior volume and moving the applicator from a position below the opening to a position such that at least a portion of the applicator is through the opening of the delivery device.
